(19) United States
(12) Patent Application Publication
(10) Pub. No.: US 2006/0238231 A1
(43) Pub. Date: Oct. 26, 2006

(54) Pulse signal generator device

(75) Inventor: Kohei Mutaguchi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/188,902

(22) Filed: Jul. 26, 2005

(30) Foreign Application Priority Data
Apr. 20, 2005 (JP) 2005-122114

(51) Int. Cl. G06F 1/04

(52) U.S. Cl. 327/291

(57) ABSTRACT

To allow changes in period and duty ratio at a desired timing without control of the timing for setting values of the period and duty ratio by a CPU, a unit 1 for storing a plurality of values of periods, a unit 2 for storing a plurality of values of duty ratios, a circuit 3 for counting the number of input clock pulses, a circuit 4 for outputting an agreement signal when the output of the circuit 3 and a value stored in the unit 2 agree with each other, a circuit 5 for outputting a pulse signal at a determined point, which is the output of the agreement signal, and a circuit 6 for selecting any period of the periods stored in the unit 1 in response to input of a control signal and outputting a value corresponding to the selected period to the unit 2, are comprised.

### CROSS REFERENCE TO RELATED APPLICATIONS

This application is based upon and claims the benefit of priority from the prior Japanese Patent Application No. 2005-122114 filed on Apr. 20, 2005, the entire contents of which are incorporated herein by reference.

### BACKGROUND OF THE INVENTION

1. Field of the Invention

The present invention relates to a method for generating a pulse signal, and more specifically, relates to a pulse signal generator device for counting the number of input clock pulses, and for generating a PWM (Pulse Width Modulation) signal with a prescribed period and duty ratio corresponding to the count.

2. Description of the Related Art

Conventional PWM signal output devices, in general, comprise a register in which a period is set, a register in which a duty ratio is set and a timer for counting the number of input clock pulses, and performing output operation of a pulse signal with established and prescribed period and duty ratio, after comparing a value set in the registers with a count value in the timer.

The count value of the timer is set at “0” at startup of the device, and afterward, the count value is incremented every time a clock pulse is input. When the count value becomes equal to the value set in the duty setting register, the PWM output signal is inverted, and in addition, when the count becomes equal to the value set in the period setting register, the PWM output signal is also inverted, the count value of the timer is reset to “0”, and the counting operation is continued.

As a method for setting the number of clock pulses corresponding to a period and a duty ratio in the period setting register and the duty setting register, a method, which has been commonly used, is, for example, that a CPU receives an interrupt request signal from a pulse signal generator device and sets a count corresponding to a period and a duty ratio in response to the interrupt request signal. A conventional example of changing operation of the period and the duty ratio in accordance with the interrupt request is explained with reference to FIG. 1 and FIG. 2.

FIG. 1 is a configuration block diagram of a conventional example of a pulse signal generator device.

In FIG. 1, a pulse signal generator device 200 is connected to a CPU 201 by a CPU bus interface circuit 202, and comprises a period setting register 203, a duty setting register 204, a timer counter 205, a period value comparison circuit 206, a duty value comparison circuit 207 and a PWM output signal generator circuit 208.

Here, an interrupt request, requesting the rewriting of setting values in the period setting register 203 and the duty setting register 204, is issued from the pulse signal generator device 200 to the CPU. The conditions of the interrupt request issued are such that the count value of the timer counter 205 reaches a value corresponding to the period or that the counter value reaches a value corresponding to the duty ratio. However in the timing chart in FIG. 2, when a duty value comparison circuit 207 determines that a timer count value 254 output from the timer counter 205 corresponds with a duty value 251 output from the duty setting register 204, an interrupt request is output to the CPU 201.

In the operational timing chart of FIG. 2, there are two sets of a period value and a duty value, these two sets of a period value and a duty value are alternately set every period in the period setting register 203 and the duty setting register 204 from the CPU 201 via the bus interface circuit 202, and by so doing, output operation of the PWM signal is performed.

The CPU 201 sets new values in the period setting register 203 and the duty setting register 204 in response to the interrupt request, which is output at such a point in time that a timer count value 254 by from the timer counter 205 corresponding with a value set in the duty setting register 204 is detected. In the next period, output operation of a PWM signal corresponding to the period value and the duty ratio value is performed. Then, the setting value of the period setting register 203 is changed from “n” to “p”, and that of the duty setting register 204 is changed from “m” to “q”.

In FIG. 2, in addition, (2) is the time period of the “L” level derived from the product of a clock number “m+1”, which corresponds to the duty ratio within a period, and the clock period “T”; however in the following description, this time period is referred to as “duty ratio” or “duty” for simplicity.

There is, however, a possibility that because the time period from the output of the interrupt request from the pulse signal generator device 200 to the CPU 201 until recognition of the interrupt request by the CPU 201 is not constant, that update of setting values in the period setting register 203 and the duty setting register 204 may be delayed until the next period. In other words, there is a problem whereby the CPU 201 cannot perform proper control over timing of setting new values in the period setting register 203 and the duty setting register 204.

It is also possible that when changing a period value or a duty value during the output operation of the PWM signal, time lag may be caused between the point of setting a new value in the period setting register 203 and the point of setting a new value in the duty setting register 204, which are both set by the CPU 201. Then, at some CPU 201 writing timings, only the value of the period setting register 203 is updated and the operation of the next period starts, leaving the setting value of the duty setting register unchanged, causing the problem that a pulse signal with a period and a duty ratio intended by the update operation cannot be generated.

In view of such problems that CPU processing corresponding to interrupt request signals in the conventional art, in conventional art documents (such as Japanese laid-open disclosure public patent bulletin No. 56-154747 (the prior Japanese Patent Application No. 55-57775)), a technique for performing sequence control of a copy process by counting timing pulses with a counter, which operates independently from the operation of a microcomputer, and causing the microcomputer to read the counting value instead of inputting a timing pulse, which is generated in synchronization with the rotation of photoreceptor of a copy machine or its driving motor etc., to an interrupt terminal of a microcomputer.

In conventional art documents (such as Japanese laid-open disclosure public patent bulletin No. 2001-16081 (the prior Japanese Patent Application No. 11-184116)) relating to a technique of writing to a period setting register and a duty setting register, of a pulse width modulation signal generator with the following feature is described. A second period setting register and a second duty setting register are provided in addition to the registers above, and when making changes to the period and duty ratio, a CPU writes new values to the second period setting register and the second duty setting register with arbitrary timing. On the completion of writing to these two registers, the period value is transferred from the second period setting register to the period setting register, and the duty value is transferred from the second duty setting register to the duty setting register.

However, there are problems: the technique disclosed in Japanese laid-open disclosure public patent bulletin No. 56-154747 cannot be applied to the object of the present invention, which is the CPU writing values to a period setting register and a duty setting register; and with the technique disclosed in Japanese laid-open disclosure public patent bulletin No. 2001-16081, the CPU cannot control the timing for setting new values in the newly-comprised second period setting register and second duty setting register.

There is another problem that update timing of the setting value of the period setting register and the duty setting register occurs at the same point in time as the CPU completes data writing to the second period setting register and the second duty setting register. It is possible that delay for several periods can be caused from the point of the start of the writing operation of these values by the CPU to the point that the period and the duty ratio are actually updated and used for the output of the PWM signal.

Furthermore, there is also another problem: A PWM signal is used for accurate positional control in the operation of a lens position control element configured in a digital camera, for example. In such accurate positional control, as explained in FIG. 2, it is necessary to change the period and the duty ratio every period, for example; however, with the technique disclosed in Japanese laid-open disclosure public patent bulletin No. 2001-16081, such accurate positional control cannot be performed.

### SUMMARY OF THE INVENTION

It is an object of the present invention, in view of the above problems, to provide a pulse signal generator device in which a CPU does not have to control timing for setting new values in a period setting register and a duty setting register, and a period and a duty ratio of a PWM signal can be changed every period at a desired timing, for example.

In order to solve the problem, a pulse signal generator device relating to the present invention comprises a period storage unit for storing a plurality of different pulse signal period values, a period hold unit for holding a value corresponding to any of a plurality of periods stored in the period storage unit, a counting circuit for counting the number of input clock pulses, a period comparison circuit for comparing a count value of the number of clock pulses output from the counter circuit and the value held in the period hold unit and outputting a period agreement signal when the two values agree with each other, a pulse signal output circuit for outputting a pulse signal at a pulse period determination timing which is the point in time of the output of the period agreement value by the period comparison circuit, and a selection control circuit for selecting any of a plurality of period values stored in the period storage unit in response to the control signal input and outputting the value corresponding to the selected period to the period hold unit.

### BRIEF DESCRIPTION OF THE DRAWINGS

FIG. 1 is a configuration block diagram of a conventional example of a pulse signal generator method;

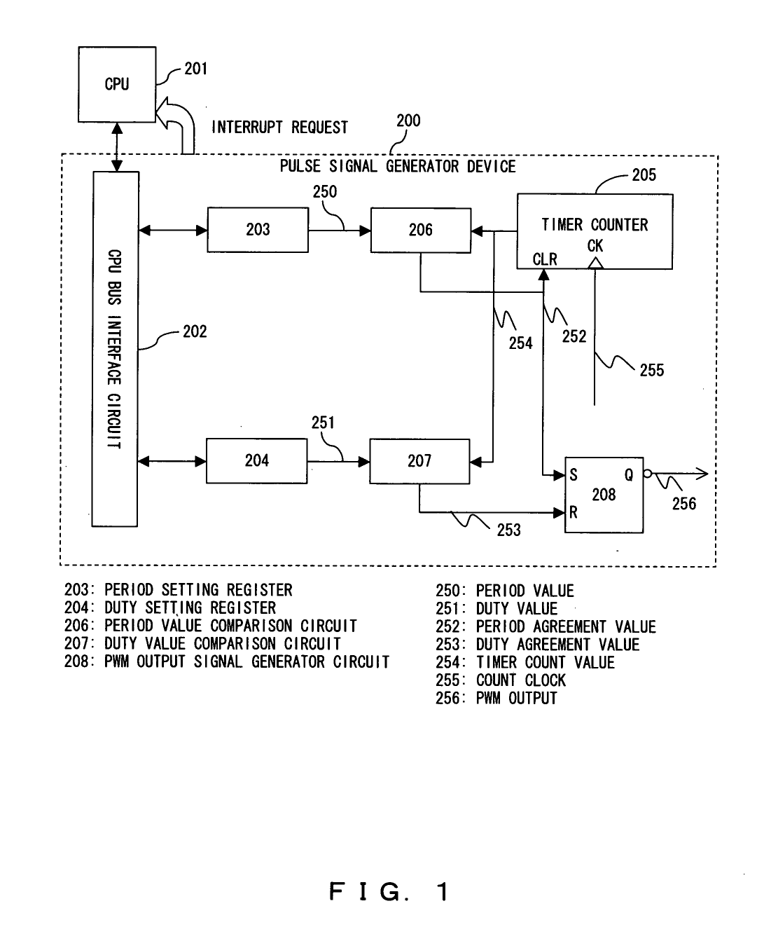

FIG. 2 is a timing chart of PWM signal output operation in the conventional example of FIG. 1;

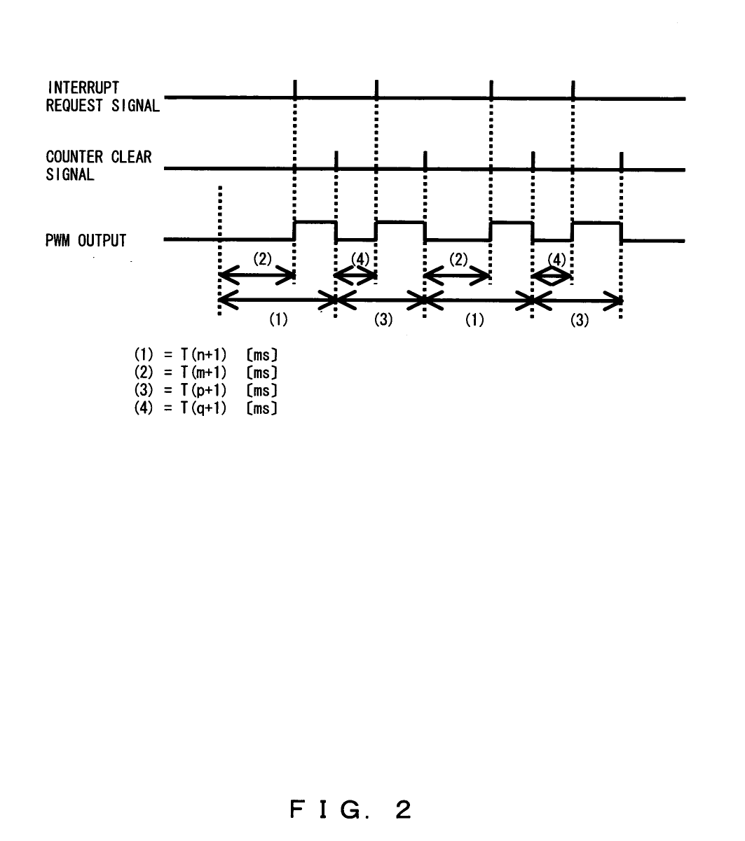

FIG. 3 is a block diagram of a fundamental configuration of a pulse signal generator device of the present invention;

FIG. 4 is a configuration block diagram of a pulse signal generator device of the first embodiment;

FIG. 5 is an entire timing chart of a PWM signal output operation in the first embodiment;

FIG. 6 is a detailed timing chart of period/duty update operation in the first embodiment;

FIG. 7 is an entire timing chart of PWM signal output operation in the second embodiment;

FIG. 8 is a configuration block diagram of the switch signal generator circuit in the second embodiment;

FIG. 9 is a detailed timing chart of period/duty update operation in the second embodiment;

FIG. 10 is an entire timing chart of the PWM signal output operation in the third embodiment;

FIG. 11 is a configuration block diagram of the pulse signal generator device in the third embodiment;

FIG. 12 is a configuration block diagram of the select signal generator circuit in the third embodiment; and

FIG. 13 is a detailed timing chart of period/duty selector signal output operation in the third embodiment.

### DESCRIPTION OF THE PREFERRED EMBODIMENTS

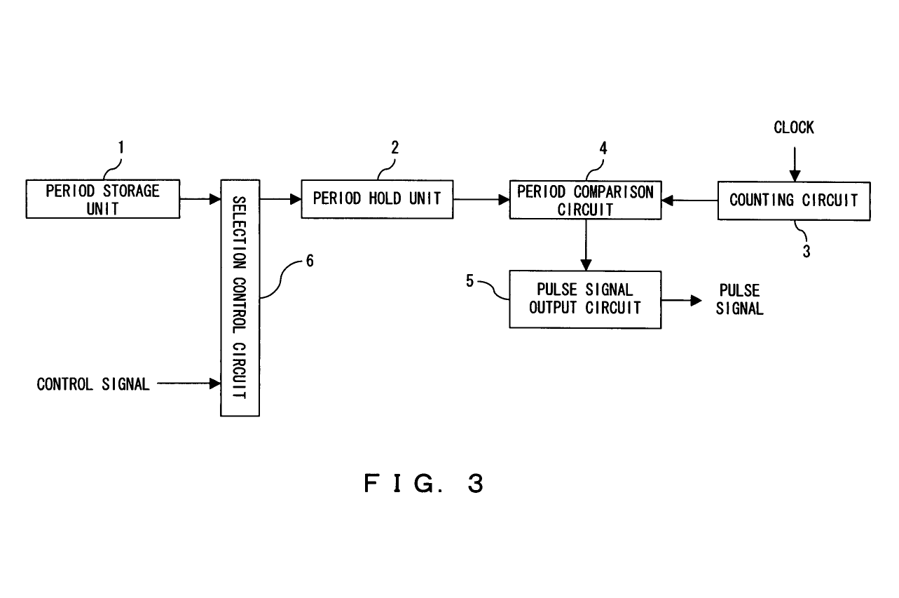

FIG. 3 is a block diagram of a fundamental configuration of a pulse signal generator device of the present invention. In FIG. 3, a pulse signal generator device of the present invention comprises at least a period storage unit 1, a period hold unit 2, a counting circuit 3, a period comparison circuit 4, a pulse signal output circuit 5 and a selection control circuit 6.

The period storage unit 1 is for storing a plurality of values with different pulse signal periods, and in the present embodiment, it is for storing timer count values, for example, corresponding to period values. The period hold unit 2 holds a value corresponding to any of a plurality of periods stored in the period storage unit 1, for example, the above timer count value.

The counting circuit 3 is, for example, a counter counting the number of input clock pulses. The period comparison circuit 4 compares a count value of the clock count output by the counting circuit 3 with a value corresponding to the period held in the period hold unit 2, and outputs a period agreement signal when both values agree with each other. The pulse signal output circuit 5 outputs a pulse signal, or PWM signal for example, on output of the period agreement signal as pulse period determination timing.

The selection control circuit 6 selects any of a plurality of period values stored in the period storage unit 1, and outputs the value corresponding to the selected period to the period hold unit 2 in response to input of a control signal, such as a load signal generated when the count number of the counting circuit 3 is cleared by a period agreement signal and causing the period hold unit 2 to hold the value corresponding to any of the period values.

The pulse signal generator device of the present invention comprises a duty ratio storage unit for storing a plurality of values with different pulse signal duty ratios, a duty ratio hold unit for holding values corresponding to any of a plurality of duty ratios stored in the duty ratio storage unit, a counting circuit for counting clock numbers, a duty ratio comparison circuit for comparing a value held in the duty ratio hold unit with a count value output from the counting circuit, and for outputting a duty ratio agreement signal when both values agree with each other, a pulse signal output circuit for outputting a pulse signal at the output of the duty ratio agreement signal as pulse width determination timing, and a selection control circuit for selecting any of a plurality of values of duty ratios stored in the duty ratio storage unit in response to the control signal input, and for outputting a value corresponding to the selected duty ratio to the duty ratio hold unit.

It is possible that the present embodiment comprises a period storage unit, a period hold unit, a duty ratio storage unit, a duty ratio hold unit, a counting circuit, a period comparison circuit and a duty ratio comparison circuit, in which a pulse signal output circuit outputs a pulse signal at period agreement signal output as pulse period determination timing and at duty ratio agreement signal output as a pulse width determination period, and the selection control circuit outputs a value corresponding to any of a plurality of period values to the period hold unit in response to input of the control signal and outputs a value corresponding to any of a plurality of duty ratios to the duty ratio hold unit.

As explained above, according to the present invention, for example, before startup of the pulse signal generator device, a plurality of values of different periods and/or a plurality of different duty ratios values are stored in the period storage unit and/or the duty ratio storage unit, this plurality of values of periods and/or a plurality of values of duty ratio are selected, and a pulse signal is output in accordance with the selected period, and/or the selected duty ratio.

According to the present invention, before startup of the pulse signal generator device, a plurality of different period values and/or a plurality of different duty ratio values are written to the period storage unit and/or to the duty ratio storage unit, respectively, by the CPU, and therefore an interrupt request for requesting to write a period and/or a duty ratio does not need to be output from the pulse signal generator device to the CPU. It is thus possible to generate a pulse signal with its pulse period and duty ratio properly controlled in accordance with a preset period and/or duty ratio.

Because control of the timing to switch the pulse period and/or duty ratio is based on the count value of a clock number of the timer serving as a counting circuit, it is possible that update of the period and/or the duty ratio is properly controlled at an intended timing every one period, for example.

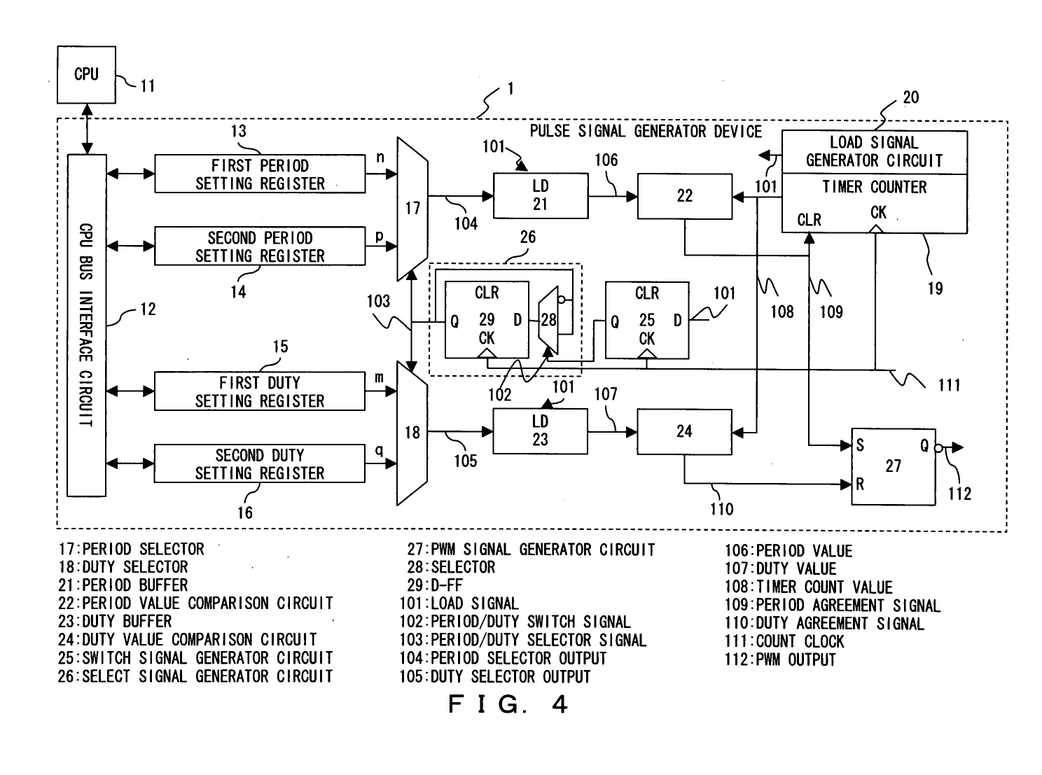

FIG. 4 is a configuration block diagram of the pulse signal generator device in the first embodiment of the present invention. In FIG. 4, a pulse signal generator device 10 is connected to a CPU 11 by a CPU bus interface circuit 12. Inside the generator device 10 comprises first and second period setting registers 13 and 14 and first and second duty ratio setting registers 15 and 16, to which different values of periods and different values of duty ratios (or corresponding timer count values) are set respectively, two selectors 17 and 18 for selecting output of the registers, a timer counter 19 for counting the clock number from the starting point to the end point within one period, a load signal generator circuit 20 for generating a load signal, which becomes “H” when the count value of the counter 19 is “0”, a period buffer 21 for holding either one of two periods (or corresponding timer count values), a period value comparison circuit 22 for comparing the output of the period buffer 21 with the count value output from the timer counter 19, a duty buffer 23 for holding either one of two duty ratios (or corresponding timer count values), and a duty value comparison circuit 24 for comparing the output of the duty buffer 23 with the count value of the timer counter 19.

The pulse signal generator device 10 also comprises a switch signal generator circuit 25 for outputting a period/duty switch signal 102 in response to input of a load signal 101 generated by the load signal generator circuit 20, a select signal generator circuit 26 for providing a period/duty selector signal 103 to the two selector 17 and 18 in response to the output of the switch signal generator circuit 25, and a PWM signal generator circuit 27 basically configured by set/reset flip-flops (RS-FF), and the select signal generator circuit 26 is configured by a selector 28 and a data flip-flop (D-FF) 29. In claims 1, 2 and 10 of the present invention, a pulse signal output circuit is equivalent to the PWM signal generator circuit 27 and the selection control circuit is equivalent to the switch signal generator circuit 25, the select signal generator circuit 26, the period selector 17 and/or the duty selector 18.

In the present embodiment, before startup of the pulse signal generator device 10 or during operation halt of the timer counter 19, a plurality of values of a period and a duty ratio are stored in each registers by the CPU 11 via the CPU bus interface circuit 12. In the first embodiment, “n” is stored in the first period setting register 13, “p” is stored in the second period setting register 14, “m” is stored in the first duty setting register 15 and “q” is stored in the second duty setting register. That is, in the present embodiment, driving operation by a PWM signal output from the pulse signal generator 10 is determined in advance, and a plurality of period values and duty ratio values corresponding to the operation are set in the registers respectively.

In FIG. 4, the load signal 101, output by the load signal generator circuit 20, is provided to the switch signal generator circuit 25 as explained above, and the period/duty switch signal 102, output from the circuit 25, is provided to the select signal generator circuit 26. One of the two period values and one of the two duty ratio values are selected by the selectors 17 and 18 according to the period/duty selector signal 103 and are provided to the period buffer 21 as the period selector output 104 and to the duty buffer 23 as the duty selector output 105, respectively. The period value 106 and the duty value 107, output from those buffers, are provided to the comparison circuits 22 and 24, respectively, and they are compared with the timer count value 108, output from the timer counter 19.

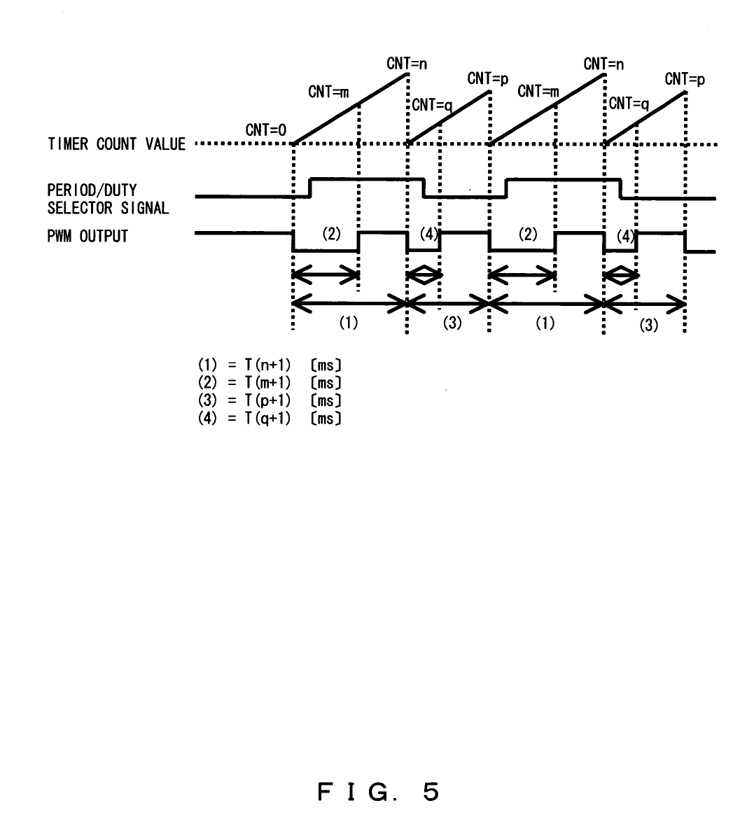

FIG. 5 is an entire timing chart of an operation example of the pulse signal generator device in the first embodiment. In this first embodiment, as described in FIG. 5, in the first period after resetting the register value, for example, output operation of the PWM signal is performed in accordance with a period “n” set in the first period setting register 13 and a duty ratio “m” set in the first duty setting register 15.

In the second period, the PWM output operation, corresponding to a period “p” set in the second setting register 14 and a duty ratio “q” set in the second duty setting register 16, is performed. In the third period, the same operation as the first period is performed, and in the forth period, the same operation as the second period is performed, and the operations are continued in such a manner.

In other words, a value of a period indicated by (1) in FIG. 5 can be represented as T(n+1) where the clock period is T, using the value “n” set in the first period setting register 13, and while the PWM output is “L” in (2), the period value can be represented as T(m+1) using T and the value “m” set in the first duty setting register 15. Here, for example, “n+1” is the clock number of the first period. An explanation of the change in the period/duty selector signal in FIG. 5 is provided later.

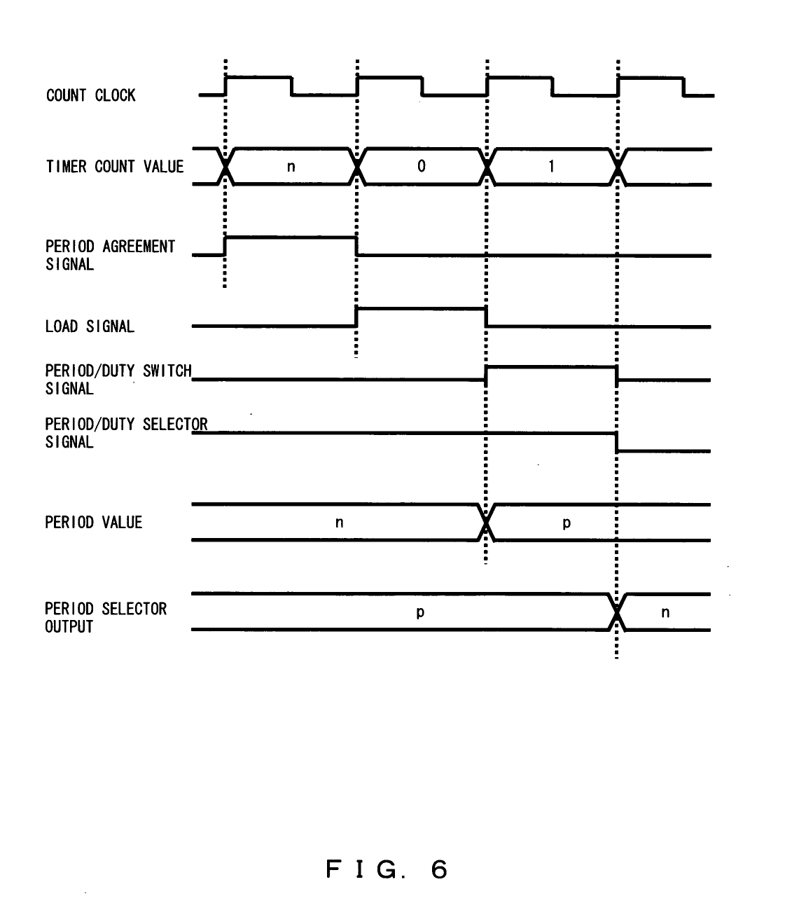

FIG. 6 is a detailed timing chart of period selection operation in the first embodiment. It is a timing chart showing details of the end of the first period and the beginning of the second period of the entire timing chart of FIG. 5. In the first embodiment, before startup of the pulse signal generator device 10 or during halting operation of the timer counter 19, as a result of a reset operation, the value of the period/duty selector signal, provided to the two selectors 17 and 18, is “L”, then, the period selector 17 outputs “n” as the value of the period to the period buffer 21 and the selector 18 outputs “m” as the value of the duty to the duty buffer 23. Immediately after the startup of the device 10, that is, when the timer count value is still “0”, the period and the duty values are latched in the period buffer 21 and the duty buffer 23, respectively.

In FIG. 6, when the output count value from the timer counter 19 is “n” at the time when the first period ends, the period agreement signal is output from the period value comparison circuit 22. At the next clock, the timer count value is reset to “0”, and as explained above, the load signal 101 from the load signal generator circuit 20 becomes “H” at this time. The load signal 101 is provided to the switch signal generator circuit 25 consisting of the D-FF, and, being one clock behind from the circuit 25, the period/duty switch signal 102 is provided as the selector control signal to the selector 28 in the select signal generator circuit 26.

The selector 28, when the value of the period/duty switch signal is “H”, provides an input signal from an upper input terminal, that is, the inverted signal of the output from the D-FF 29, to the D-FF 29, and when the value of the period/duty switch signal is “L”, an input signal from a lower input terminal, that is, the output from the D-FF 29, is output to the D-FF 29.

In other words, the select signal generator circuit 26 performs a toggle operation so as to invert the period/duty switch signal 102, output from the switch signal generator circuit 25 every time the output signal is input, and provides the result of the toggle operation to the two selectors 17 and 18 as a period/duty selector signal 103. In FIG. 6, then, the period/duty selector signal 103 is inverted at the next clock pulse after the input of the period/duty switch signal, and becomes “L”. As explained above, at the time of a reset, the period/duty selector signal 103 is reset to “L”; however, the value of the period/duty selector signal is inverted to “H” at the time when the timer count value changes from “1” to “2” in accordance with the load signal 101 input at the beginning of the first period of the timing chart in FIG. 5.

In FIG. 6, the value of the period stored in the period buffer 21 is changed from the value “n” set in the first period setting register 13 to the value “p” set in the second period setting register 14 at the next clock pulse from the input of the load signal 101. That is, the value of the period/duty selector signal 103 is “H” until this point in time, the value “p” set in the second period register 14 is output from the period selector 17, and the value is loaded to the period buffer 21. At and after the period/duty selector signal 103 becomes “L”, the period selector 17 outputs the value “n” set in the first period setting register 13. The PWM output changes from “H” to “L” when the timer count value changes from “n” to “0”.

A detailed timing chart of the operation of selecting the value of the period is shown in FIG. 6 the same operation is performed to select the value of the duty. That is, the period/duty selector signal 103 is provided to the duty selector 18 as the selector control signal, and the value of the duty held in the duty buffer 23 changes from “m” to “q” at the next clock pulse after the load signal is input. The output of the duty selector 18 is “q” until the input of the period/duty switch signal, and becomes “m” after the period/duty selector signal is inverted. In the second period in FIG. 5, for example, when the count value of the timer counter 19 reaches “q”, the duty agreement signal 110 is provided to a reset input terminal of the PWM signal generator circuit 27 from the duty value comparison circuit 24, and the value of the PWM output is “H” as the inverted output of the SR-FF.

In this first embodiment, the values of the period and the duty ratio are selected in accordance with the load signal 101, which the load signal generator circuit 20 outputs, at the point in time that the count value of the timer counter 19 is “0”; however, the period and the duty ratio can also be selected by providing the period agreement signal 109, output from the period value comparison circuit 22, instead of the load signal 101 to the switch signal generator circuit 25. In such a case, in response to the input of the period agreement signal, because the period/duty switch signal 102 is output one clock behind the input, the selection of the period and the duty should be carried out one clock ahead.

Additionally, as input to the switch signal generator circuit 25, it is possible to use the duty agreement signal 110, output by the duty value comparison circuit 24, instead of the load signal 101. In this case, change in the period values and the duty values is performed at the end of the time frame (2) of the first period in FIG. 5, for example, and the outputs of the period selector 17 and of the duty selector 18 are changed; however, the changed values are latched by the period buffer 21 and the duty buffer 23 at such a time when the clock has advanced one clock pulse from the time when the load signal 101 was output from the load signal generator circuit 20 at the end of the first period.

The PWM signal output operation in the first embodiment is further explained. When the pulse signal generator device 10 is started, the timer counter 19 increments the count value 108 every time the count clock 111 pulse is input, and when the count value 108 reaches “m”, the duty agreement signal 110 is output from the duty value comparison circuit 24, the PWM output signal, output from the PWM signal generator circuit 27 of which the reset terminal is provided with the signal 110, becomes “H” level.

When the count value 108 of the timer counter 19 is “n”, the period agreement signal 109 is output from the period value comparison circuit 22, the signal is provided to a set terminal of the PWM signal generator circuit 27, and the PWM output level 112 becomes “L” level. The period agreement signal 109 is provided to a clear terminal of the timer counter 19, when inputting the period agreement signal 109 the timer count value 108 output from the timer counter 19 is cleared to “0”, and at that time, the load signal 101 is output from the load signal generator circuit 20. By repeating such processes which change the value of the period and the value of the duty ratio, the operation of the pulse signal generator device 10, of which a timing chart is shown in FIG. 5, is realized.

In the first embodiment, a set of a value of the period and a value of the duty ratio is stored in a two-set register, and the PWM output signal is obtained by alternately using the values of the period reset and the duty ratio every period. The CPU 11 only sets each of two values of the period and the duty ratio to registers before the startup of the pulse signal generator device 10 or during halting of the operation of the timer counter 19, and does not write the values to the registers during the output operation of the PWM signal; therefore the pulse signal generator 10, which does not require control of the timing of the CPU 11 setting values in these registers, can be provided.

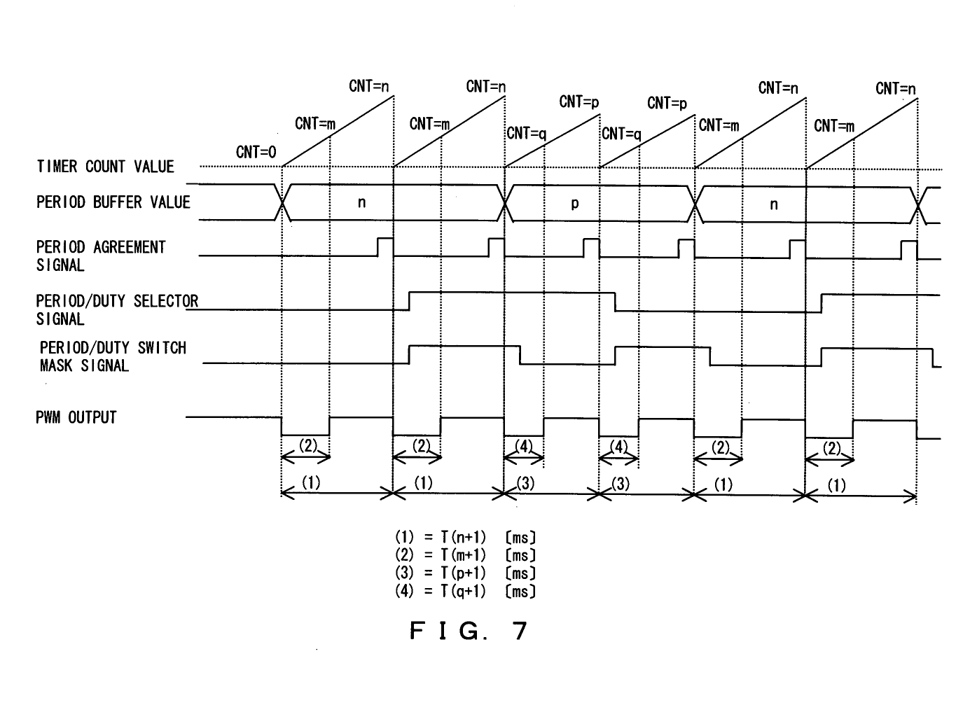

A second embodiment of the present invention is explained next with reference to FIG. 7 through FIG. 9. FIG. 7 is an entire timing chart of the PWM signal output operation in the second embodiment. In the second embodiment, two sets of the values of the period and the duty ratio are used in the same way as the first embodiment; however unlike the first embodiment where the values of the two sets of the period and the duty ratio are not used alternately from period to period, the PWM signal is output in such a way that the values of the two sets are alternately used for every other period.

In FIG. 7, in other words, during the first period and the second period, the PWM signal is output by using the values of “n” set in the first period setting register 13 and “m” set in the second duty setting register 15 in FIG. 4, and during the third period and the fourth period, the PWM signal is output by using values of “p” set in the second period setting register 14 and “q” set in the second duty setting register 16. In and after the fifth period, above operation is repeated. Change in the period/duty selector signal etc. is explained later.

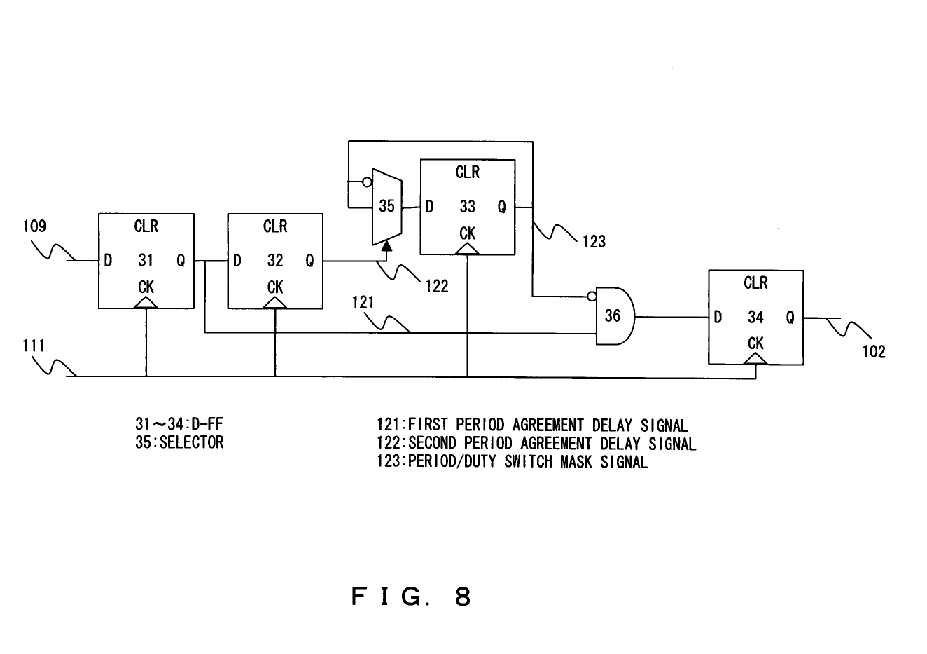

FIG. 8 is a configuration circuit diagram of the switch signal generator circuit of the second embodiment. In the first embodiment of FIG. 4, although the switch signal generator circuit 25 comprises a single D-FF, this is basically different from the second embodiment where the switch signal generator circuit comprises four D-FFs 31-34, a selector 35, and an AND gate 36. The load signal 101 is input to the switch signal generation circuit 25 in FIG. 4; however the period agreement signal 109 is input in the second embodiment. The point that the load signal is provided to the load terminals of the period buffer 21 and the duty buffer 23 and is used to latch the output from each of the selectors 17 and 18, is the same as the first embodiment.

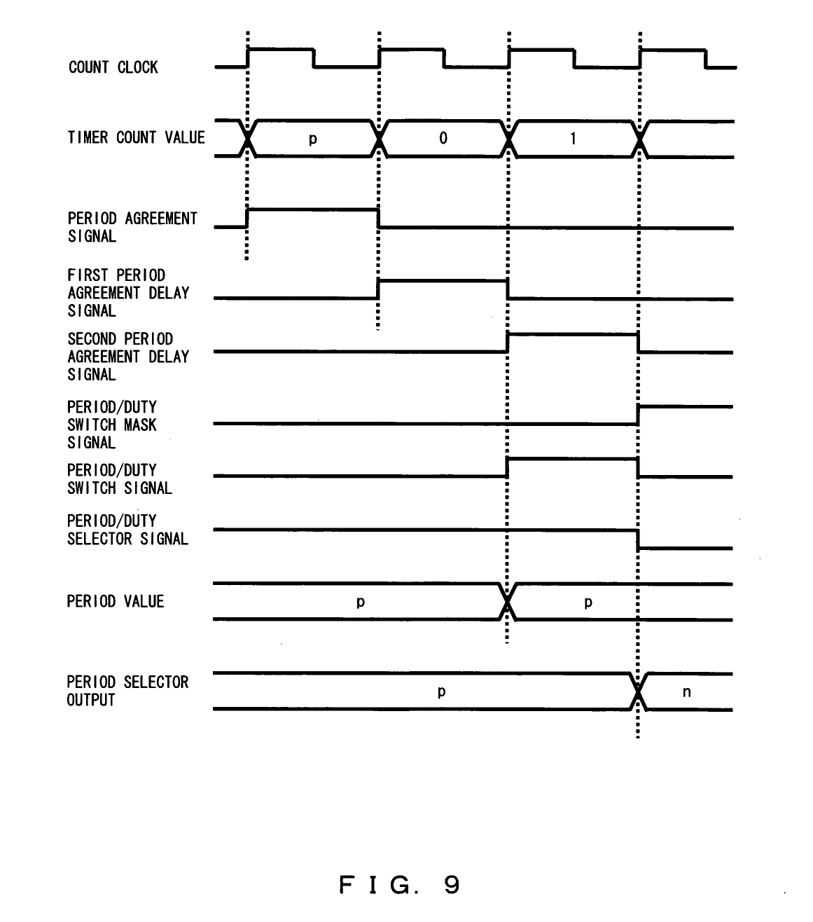

An explanation of selection of the value of the period of operation of the switch signal generation circuit in FIG. 8 is provided using a timing chart in FIG. 9. The timing chart in FIG. 9 is a timing chart showing details of the period value selection operation from the end of the third period to the beginning of the fourth period of FIG. 7.

To explain the operations up to the above point using FIG. 7, the value of the period held in the period buffer 21 in the first period and the second period is “n”, and by outputting the period agreement signal 109 at the end of the first period, the period/duty selector signal and a period/duty switch mask signal are changed from “L” to “H” at the beginning of the second period. Here, the value “L” is assumed to be set on reset.

In response to the period agreement signal 109 output at the end of the second period, the value of the period/duty switch mask signal changes to “L” at the beginning of the third period, while the period/duty selector signal remains at “H”, waiting for the timing of the operation in FIG. 9. An explanation of the changes in the period/duty selector signal and the period/duty switch mask signal is further provided in FIG. 9.

In FIG. 8, when the timer count value becomes “p” at the end of the third period of FIG. 7, the period agreement signal 109 is input to the D-FF 31. This signal is delayed by one clock by the D-FF 31 shown in FIG. 9, and is provided to one input terminal of each of the D-FF 32 and the AND gate 36, as a first period agreement delay signal 121. The output of the D-FF 32 is further delayed by one clock and output for selector control to the selector 35 as a second period agreement delay signal 122.

The selector 35 and the D-FF 33 are for performing toggle operation to invert the output of the D-FF 33 for every input of the second period agreement delay signal 122 in the same way as the selector 28 and the D-FF 29 of the first embodiment of FIG. 4, and a period/duty switch mask signal 123, which is the output of the above operation is provided to another terminal (negative logic) of the AND gate 36. That is, the period/duty switch mask signal 123 changes from “L” to “H” at the next clock pulse from input of the second period agreement delay signal 122 to the selector 35.

The first period agreement delay signal 121, output from the D-FF 31, is input to one input terminal of the AND gate 36, as explained above. Because the value of the period/duty switch mask signal 123 is “L” at this point in time, the first period agreement delay signal 121 is provided to the D-FF 34 via the AND gate 36, and, one clock pulse later, the period/duty switch signal 102 as the output of the D-FF 34 becomes “H”. In the same way as in FIG. 4, this signal is provided as a selector control signal to the selector 28, and the period/duty selector signal 103 as the output of the D-FF 29 is inverted at the next clock pulse by the above-explained toggle operation. Additionally, at the next clock pulse after the inversion, the value of the period output from the period selector 17 changes from “p” to “n”, and is loaded into the period buffer 21 in response to the last period agreement signal output in the fourth period; however until then, the value of the period held in the period buffer 21 remains at “p”.

In FIG. 8, the period/duty switch mask signal 123, which the D-FF 33 outputs, is for changing the set of period and duty every two periods, even though the period agreement signal is output at the end of each period, by preventing the switch between period and duty at the beginning of the third period, for example. That is, at the beginning of the third period in FIG. 7, for the value of the period/duty switch mask signal 123 being “H”, the AND gate 36 in FIG. 8 blocks the first period agreement delay signal 121, which is the output of the D-FF 31. For that reason, the period/duty switch signal 102 does not become “H” at this point or the period/duty selector signal 103 does not invert, and a set of the period and duty ratio is used for two continuous periods.

In the second embodiment, the outputs of the period selector 17 and the duty selector 18 are updated every two periods, and as in FIG. 7, the output operation of the PWM signal is repeated with the set of the period and the duty ratio being changed every two period. In the second embodiment also, the CPU only sets the values of the period and the duty ratio in the registers in advance, and does not perform operations for writing the values during the output operation of the PWM signal.

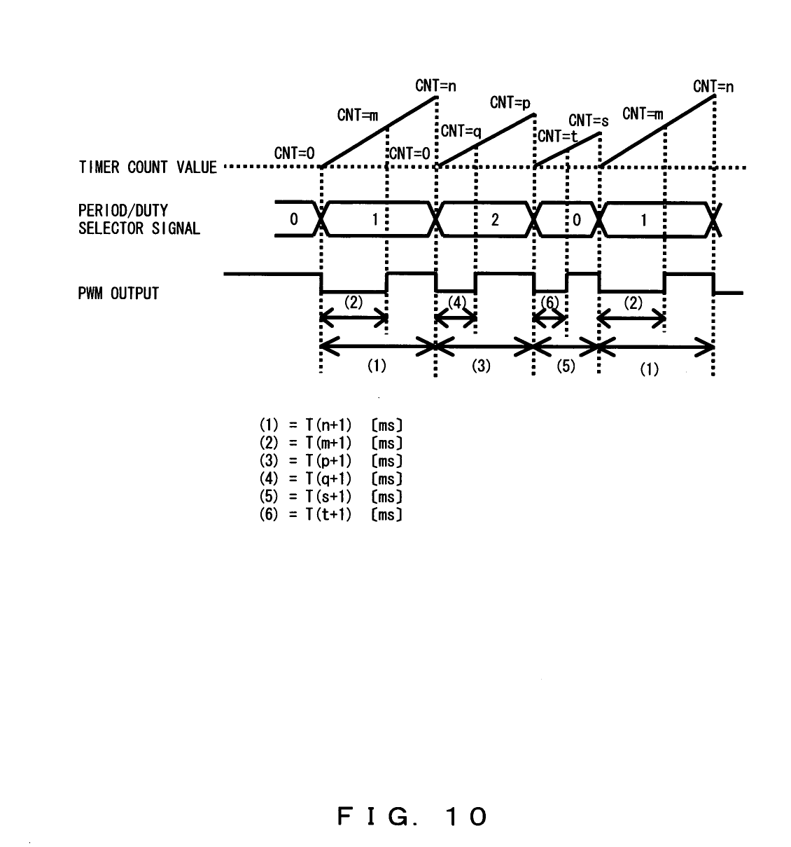

Finally, an explanation of the third embodiment is provided with reference to FIG. 10 through FIG. 13. FIG. 10 is an entire timing chart of the PWM signal output operation of the third embodiment. In this third embodiment, unlike the first or the second embodiments, three sets of the period and the duty ratio are used, and these three sets are used alternately in each period and the output operation of the PWM signal is repeated.

In other words, in FIG. 10, as the count value corresponding to the period and the duty ratio, “n” and “m” are used in the first period; “p” and “q” in the second period; and “s” and “t” in the third period, and this operation is repeated in and after the fourth period. As the value of the period/duty selector signal 103 for controlling the selection of the sets of the period and the duty ratio, three values of “0”, “1” and “2”, to be explained later, are used in correspondence with the three sets. The value is set to “0” at reset, and by changing the value to “1”, “2”, “0”, “1”, . . , thereafter the count value corresponding to the period or the duty ratio is updated.

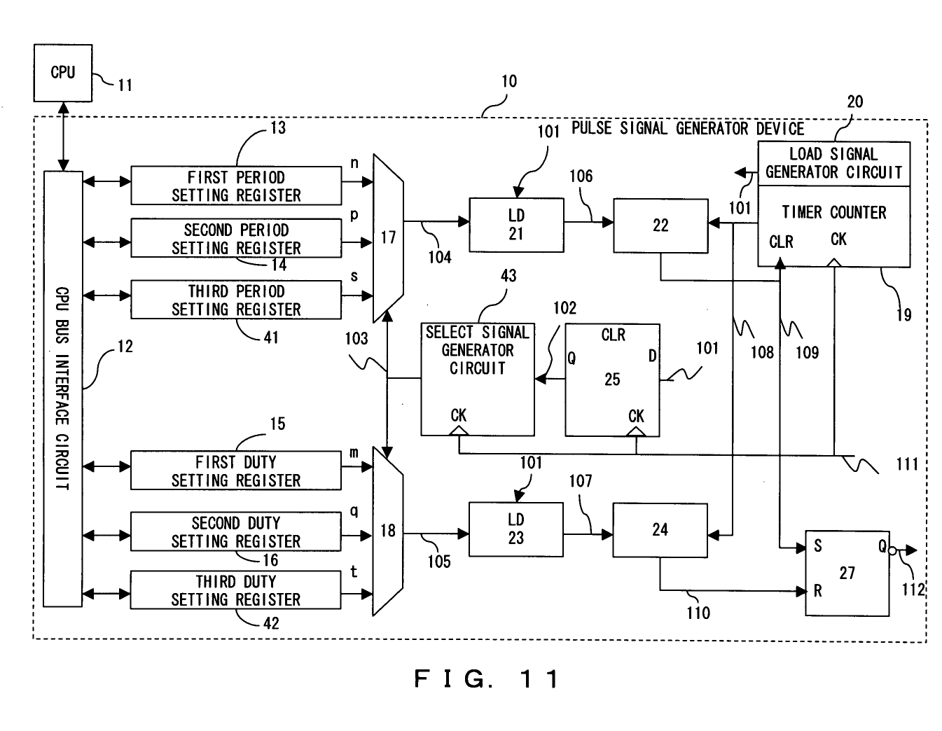

FIG. 11 is a configuration block diagram of the pulse signal generator device of the third embodiment. Compared with the first embodiment of FIG. 4, FIG. 11 has a third period setting register 41 added as a period setting register, and a third duty setting register 42 added as a duty setting register. Another difference is that a select signal generator circuit 43 with a configuration different from the select signal generator circuit 26, comprising the selector 28 and the D-FF 29 of FIG. 4, replaces the circuit 26.

In the third embodiment, the CPU 11, before startup of the pulse signal generator device 10 or during halting of operation of the timer counter 19, sets “n” in the first period setting register 13, “p” in the second period setting register 14 and “s” in the third period setting register 41, and it also sets “m” in the first duty setting register 15, “q” in the second duty setting register 16 and “t” in the third duty setting register 42.

When resetting, the value of the period/duty selector signal 103 is reset to “0”, and at that time, the period selector 17 outputs the value “n” set in the first period setting register 13 and the duty selector 18 outputs the value “m” set in the first duty setting register 15. In the same way as in the first embodiment, at the output of the load signal 101 from the load signal generator circuit 20, the outputs of the period selector 17 and the duty selector 18 are latched in the period buffer 21 and the duty buffer 23, respectively.

The load signal 101 is input to the switch signal generator circuit 25 and one clock after the input, it is also provided to the select signal generator circuit 43 as the period/duty switch signal 102. The outputting period/duty selector signal 103 of the select signal generator circuit 43 counts up from “0” to “2” in series, and when the count reaches “2”, the next count is reset to “0”. When the value of this signal is “0”, “n” is output from the period selector 17 and “m” is output from the duty selector 18, when the value of this signal is “1”, “p” is output from the period selector 17 and “q” is output from the duty buffer 18, and when the value of this signal is “2”, “s” is output from the period selector 17 and “t” is output from the duty buffer 18.

While these values of the period and the duty are latched in the period buffer 21 and the duty buffer 23, respectively, at the beginning of each period, the values corresponding to the period/duty selector signal 103 are output from the period selector 17 and the duty buffer 18 of the previous period. In FIG. 10, the value of the period/duty selector signal 103 is “0” before the output operation of the PWM signal starts, and the values of the period and the duty corresponding to the value of the selector signal at the beginning of the first period are latched in the period buffer 21 and the duty buffer 23, and they are used for the output operation of the PWM signal in the first period.

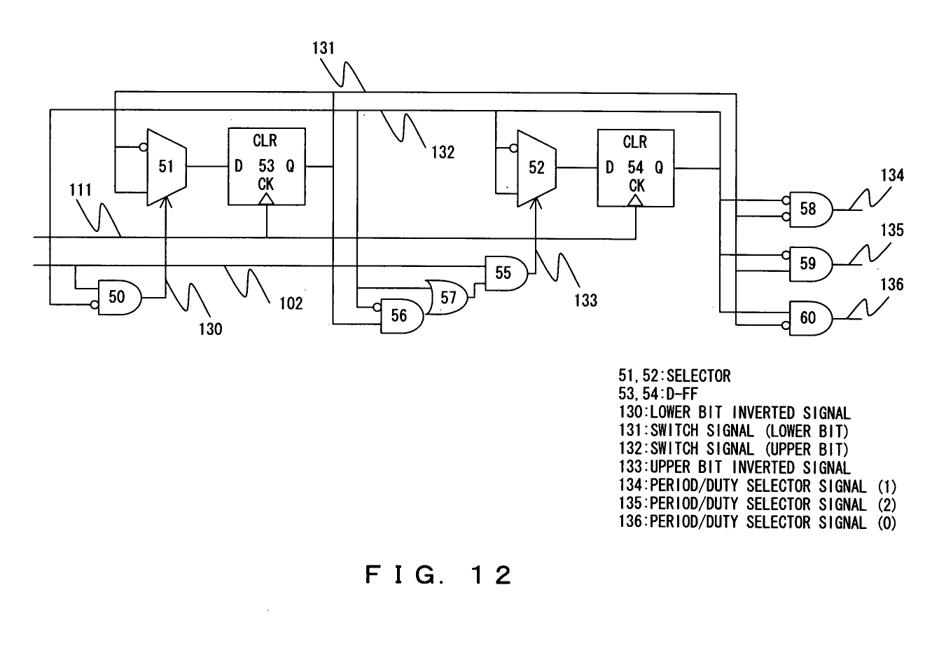

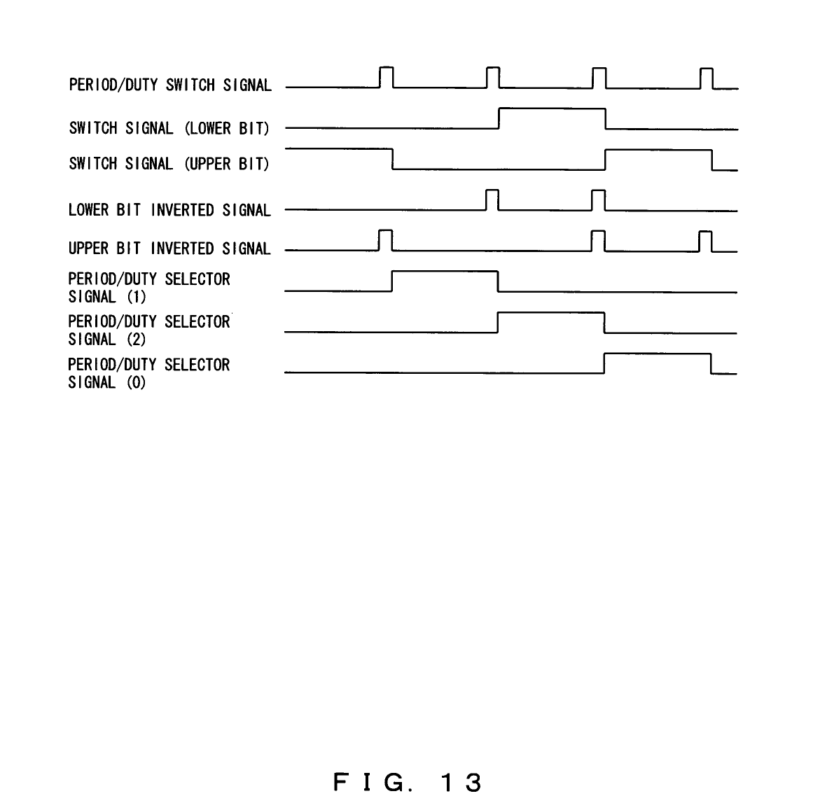

FIG. 12 is a detailed configuration block diagram of the select signal generator circuit 43 in the third embodiment. The operation in FIG. 12 is explained using the timing chart of the output operation of the period/duty selector signal described in FIG. 13. In FIG. 12, the select signal generator circuit 43 comprises an AND gate 50, two selectors 51 and 52, two D-FFs 53 and 54, two AND gates 55 and 56, an OR gate 57, and three AND gates 58-60. The selector 51 and the D-FF 53, and the selector 52 and the D-FF 54 are the pairs for performing toggle operations to invert the output of a D-FF at the input of the selector control signal of each selector individually.

The output for the AND gate 50 is provided to the selector 51 as the selector control signal. The other period/duty switch signal 102 output by the switch signal generator circuit 25 is provided to one input terminal of the AND gate 50. This period/duty switch signal 102 is, as explained in FIG. 6, output at the next clock pulse after the output of the load signal 101, and is provided to the select signal generator circuit 43 at the beginning of each period in FIG. 10. To another input terminal (negative logic) of the AND gate 50 is provided the output of the D-FF 54.

Each of the outputs from the D-FF 53 and D-FF 54 are input into three AND gates 58-60, and the output of the D-FF 53 is hereinafter referred to as a switch signal (lower bit) and that of the D-FF 54 is hereinafter referred to as a switch signal (upper bit). In other words, each bit of a 2-bit switch signal is input into three AND gates 58-60.

A switch signal (lower bit) 131 and a switch signal (upper bit) 132 are set to “L” and “H”, respectively, at reset, at the first input of the period/duty switch signal 102, the selector control signal which is output to the selector 51 as the output of the AND gate 50, or the lower bit inverted signal 130, remains at “L”, and the switch signal (lower bit) 131 is not inverted at the next clock pulse. Meanwhile, the output of the OR gate 57, of which one input terminal receives the input of the switch signal (upper bit) 132, becomes “H”, and the output of the AND gate 55 also becomes “H”; therefore the switch signal (upper bit) 132 is inverted at the next clock and becomes “L”.

The switch signal (lower bit) 131 has its value inverted at the second and the third input of the period/duty switch signal 102; however the switch signal (upper bit) 132 is not inverted at the second input of the period/duty switch signal 102. This is because the upper bit inverted signal 133, is output as a selector control signal to the selector 52 from the AND gate 35, remaining at “L”.

The period/duty switch signal 102 is input to one input terminal of the AND gate 55. To the other input terminal the output of the OR gate 57 is provided. The switch signal (upper bit) 132 is input to one input terminal of the OR gate 57, and the output of the AND gate 56 is input to the other input terminal. The switch signal (lower bit) 131 and the switch signal (upper bit) 132 are input to the AND gate 56, and the input terminal, to which the switch signal (upper bit) 132 is input, has negative logic.

The output of the OR gate becomes “H” when the switch signal (upper bit) 132 provided directly to the OR gate 57 is “H”, or when the switch signal (upper bit) 132 is “L” and the switch signal (lower-bit) 131 is “H”.

When the above conditions are satisfied and the period/duty switch signal 102 is “H”, an upper bit invert signal 133 is output from the AND gate 55, and the switch signal (upper bit) 132 as the output of the D-FF 54 is inverted. By corresponding the outputs of the three AND gates 58-60 determined in accordance with the values of such switch signals; switch signal (lower bit) 131 and switch signal (upper bit) 132 to the values of the period/duty selector signal of “1”, “2” and “0” explained in FIG. 10, update of the period and duty are performed by the period selector 17 and the duty selector 18 respectively. Both values of the switch signal (lower bit) 131 and the switch signal (upper bit) 132 are “L” immediately after the last input of the period/duty switch signal 102 of FIG. 13.

In the third embodiment, as explained above, three sets of period and duty are stored in registers, and the output of the PWM signal is performed by alternating the three sets of period and duty for every period. Thus, like the first and the second embodiments, the necessity that the CPU controls the setting timing of the values of period and duty in registers can be eliminated.

What is claimed is:

1. A pulse signal generator device, comprising:
a period storage unit for storing a plurality of different values of pulse signal period;
a period hold unit for holding a value corresponding to any of a plurality of periods stored in the period storage unit;
a counting circuit for counting the number of input clock pulses;
a period comparison circuit for comparing a count value of the number of clock pulses output from the counting circuit and the value held in the period hold unit, and outputting a period agreement signal when the two values agree with each other;
a pulse signal output circuit for outputting a pulse signal at a pulse period determination timing, which is the point in time of output of the period agreement signal by the period comparison circuit; and
a selection control circuit for selecting any of a plurality of period values stored in the period storage unit in response to the control signal input, and outputting the value corresponding to the selected period to the period hold unit.

2. The pulse signal generator device according to claim 1, further comprising:
a duty ratio storage unit for storing a plurality of different values of a pulse signal duty ratio;
a duty ratio hold unit for holding a value corresponding to any one of a plurality of different duty ratios stored in the duty ratio storage unit; and
a duty ratio comparison circuit for comparing a count value output from the counting circuit and a value held in the duty ratio hold unit and for outputting a duty ratio agreement signal when the two values agree with each other,
wherein the pulse signal output circuit outputs a pulse signal at the output of the duty ratio agreement signal by the duty ratio comparison circuit as a pulse width determination timing, and the selection control circuit, in response to the input of the control signal, further selects any of a plurality of duty ratio values stored in the duty ratio storage unit, and outputs a value corresponded to the selected duty ratio to the duty ratio hold unit.

3. The pulse signal generator device according to claim 1 or 2, wherein the count value output from the counting circuit is cleared by the period agreement signal.

4. The pulse signal generator device according to claim 3, wherein the control signal is the period agreement signal.

5. The pulse signal generator device according to claim 3, wherein the control signal, generated at the time when the count value output from the counting circuit is cleared, is a load signal, which causes the period hold unit to hold a value corresponding to any one of a plurality of the period values.

6. The pulse signal generator device according to claim 3, wherein the control signal is the duty ratio agreement signal.

7. The pulse signal generator device according to claim 3, wherein
the number of each of a plurality of the period values and/or a plurality of the duty ratio values is two, and the period hold unit and/or the duty ratio hold unit alternately holds two values corresponding to each period and/or duty ratio for every period of the pulse signal, and
the pulse signal output circuit outputs a pulse signal with a period and/or duty ratio which differs every period.

8. The pulse signal generator device according to claim 3, wherein
the number of each of a plurality of the period values and/or a plurality of duty ratio values is two, and the period hold unit and/or the duty ratio hold unit alternately holds two values corresponding to each period and/or duty ratio for every other period of the pulse signal, and
the pulse signal output circuit outputs a pulse signal with period and/or duty ratio which differs every other period.

9. The pulse signal generator device according to claim 3, wherein
the number of each of a plurality of the period values and/or a plurality of the duty ratio values is three, and the period hold unit and/or the duty ratio hold unit alternately holds two values corresponding to each of three period values and/or duty ratio values for every period of the pulse signal, and
the pulse signal output circuit outputs a pulse signal with period and/or duty ratio which differs every period.

10. A pulse signal generator device, comprising:
a duty ratio storage unit for storing a plurality of different values of pulse signal duty ratio;
a duty ratio hold unit for holding a value corresponding to any of a plurality of duty ratio stored in the duty ratio storage unit;
a counting circuit for counting the number of input clocks;
a duty ratio comparison circuit for comparing a count value of the number of clocks output from the counting circuit and the value held in the duty ratio hold unit, and outputting a duty ratio agreement signal when the two values agree with each other;
a pulse signal output circuit for outputting a pulse signal at pulse width determination timing, which is the point in time of output of the duty ratio agreement signal by the duty ratio comparison circuit; and
a selection control circuit for selecting any of a plurality of duty ratio values stored in the duty ratio storage unit in response to the control signal input, and outputting the value corresponding to the selected duty ratio to the duty ratio hold unit.
